(19) United States
(12) Patent Application Publication
(10) Pub. No.: US 2004/0113737 A1
(43) Pub. Date: Jun. 17, 2004

(54) Inductors and transformers in integrated circuits

(76) Inventors: Minghao (Mary) Zhang, Cupertino, CA (US); John C. Tung, Cupertino, CA (US)

Correspondence Address: SVPA, 7394 Wildflower Way, Cupertino, CA, 95014, US

(21) Appl. No.: 10/624,298

(22) Filed: Jul. 22, 2003

Related U.S. Application Data
(63) Continuation-in-part of application No. 10/325,038, filed on Dec. 20, 2002, now Pat. No. 6,683,480.
Application No. 10/325,038 is a continuation-in-part of application No. 10/137,988, filed on May 2, 2002, now Pat. No. 6,559,693.
Application No. 10/137,988 is a continuation-in-part of application No. 09/947,643, filed on Sep. 5, 2001, now Pat. No. 6,433,595.

(51) Int. Cl. H01F 5/00

(52) U.S. Cl. 336/200

(57) ABSTRACT

Techniques for integrating multiple transformers are disclosed. Although they can be used in other areas, the techniques are particularly suitable in integrated circuits that are demanded to be of small in size. Several winding configurations of transformers are described and all are designed to not occupy multiple individual silicon spaces that would otherwise be occupied by the multiple transformers. Further, without the multiple individual silicon spaces for the transformers, the parasitic effects that would be otherwise introduced by the transformers in the multiple individual silicon spaces will be minimized. As a result, an integrated circuit chip employing transformers implemented in accordance with one of the techniques can accommodate much higher signal frequency, and have smaller size, thus the cost of the integrated circuit chip can be substantially reduced.

### CROSS REFERENCE TO RELATED APPLICATIONS

This application is a continuation-in-part application of U.S. application Ser. No.: 10/325,038, filed Dec. 20, 2002, which is a continuation-in-part of U.S. patent application Ser. No.: 10/137,988, filed May 2, 2002, now U.S. Pat. No.: 6,559,693, which claims the priority of U.S. patent application Ser. No.: 09/947,643, filed Sep. 5, 2001, now U.S. Pat. No.:6,322,595, all of which are incorporated herein for all purposes.

### BACKGROUND OF THE INVENTION

1. Field of the Invention

The invention is generally related to the area of integrated circuits designs. More particularly, the invention is related to designs of multiple inductors or transformers in integrated circuits, wherein the transformers have strong magnetic couplings but do not occupy multiple areas. The invention is also related to transformers with one or more center-taps.

2. The Background of Related Art

An inductor is a passive electronic component that stores energy in the form of a magnetic field. In its simplest form, an inductor consists of a wire loop or coil. The inductance is directly proportional to the number of turns in the coil. Inductance also depends on the radius of the coil, the space between the turns, thickness of the material of the coil, and on the type of material around which the coil is wound. For a given coil radius and number of turns, dielectric materials such as wood, glass, and plastic result in the least inductance while ferromagnetic substances such as iron, laminated iron, and powdered iron increase the inductance. The shape of the core as well as the wire or coil can also be significant. The standard unit of inductance is the henry, abbreviated H. This is a large unit. More common units are the microhenry, abbreviated μH (1 μH=10⁻⁶ H) and the millihenry, abbreviated mH (1 mH=10⁻³ H). Occasionally, the nanohenry (nH) is used (1 nH=10⁻⁹ H). As signal frequency goes high, for example, in gigahertz range, inductors with the picohenry (pH) are often used (1 pH=10⁻¹² H).

Inductors are used with capacitors in various applications such as wireless communications. An inductor connected in series or parallel with a capacitor can provide discrimination against unwanted signals. When two or more inductors are arranged close to each other, transformers are created. In addition to the inductances, performance of the transformers is also controlled by coupling factors that are in turn determined by the proximity of the inductors. In a simple form, a transformer has two inductors, usually with an iron core, that have two lengths of wires wrapped around it. The two coils of wire do not electrically connect, and are normally attached to different circuits. Inductors and transformers have been widely used and can be found almost in every electronic circuit or system.

However, it is well known that it is difficult to fabricate inductors or transformers onto integrated circuit (IC) chips. To have usable inductors (or transformers) in IC chips, the wafer areas occupied by the inductors can be significant, resulting in very expensive IC chips. In some cases, resistors are substituted for inductors. In other cases, inductance is simulated by simple electronic circuits using transistors, resistors, and capacitors fabricated onto IC chips. As the frequency of signals goes higher, the performance of such inductor “substitutions ” are no longer satisfactory. True inductors or transformers are demanded.

FIGS. 1A-1D show respectively four transformers that are commonly used in silicon, each of the transformers including two inductors wound according to one type of winding configuration. It can be understood that, when several such transformers are used in an IC chip, multiple spaces for the transformers must be allocated, resulting in a very expensive IC chip, because the cost of an IC chip is largely determined by the physical area of the IC chip in a piece of semiconductor wafer. Essentially, the larger a physical area of an IC chip is, the higher cost the IC chip will be.

There is thus a tremendous need for solutions of providing on-chip transformers without taking up too much wafer space and, at the same time, having strong couplings to provide high secondary inductance values.

### SUMMARY OF THE INVENTION

This section as well as the abstract of the present invention is for the purpose of summarizing some aspects of the present invention and to briefly introduce one or more preferred embodiments. Simplifications or omissions may be made to avoid obscuring the purpose of the section and the abstract. Such simplifications or omissions are not intended or should not be interpreted to limit the scope of the present invention.

The present invention can be implemented as apparatus and method therefor. According to one aspect of the present invention, multiple transformers are integrated according to one of the winding configurations without occupying multiple individual silicon spaces that would otherwise be occupied by the multiple transformers. Further, it is well understood that the multiple individual silicon spaces for the transformers can result in the parasitic effects. The implementation of multiple transformers in a confined single silicon space will advantageously reduce the parasitic effects. As a result, an integrated circuit chip employing transformers implemented in accordance with the present invention can accommodate much higher signal frequency, and have smaller size, thus the cost of the integrated circuit chip can be substantially reduced.

According to another aspect of the present invention, a grounding stripe is provided or deposited between inductors or a grounding shield is provided across layers to shield or prevent from undesired couplings from the inductors or inductors on the different layers that are not supposed to be coupled to form transformers. These unwanted transformers may introduce undesirable artifacts or distortions to signals and even destabilize circuits. With the proper grounding shielding, integrated transformers do not interfere with each other and perform as they were individually implemented.

Depending on implementation of the present invention, there are several winding configurations and combinations thereof, each providing a solution of integrating several transformers in a small silicon area and believed independently novel in the art. Broadly speaking, there are types of multi-interwound(MI), multi-overlay(MO) and multi-interwound-overlay(MIO), each or combination thereof can be extended to, for example, single-layer multi-interwound (SLMI), multi-layer single-interwound(MLSI), multi-layer multi-interwound(MLMI), multi-layer multi-overlay(MLMO), and multi-layer multi-interwound-overlay(MLMIO), terms used herein to closely describe the corresponding winding configurations. In addition, special winding configurations are provided to accommodate transformers with one or more primary windings and/or one or more secondary windings. In these winding configurations, center-taps are provided to divide inductors so as to realize more than one winding or symmetric secondaries.

Depending on the winding configurations, current flows in respective inductors can be in same or opposite directions, resulting in symmetric or asymmetric winding configurations. The symmetric or asymmetric winding configurations can be advantageously used in various circuits or systems resulting in better performance and lower costs.

There are many benefits, advantages and features in the present invention. One of them is to integrate several transformers without occupying several spaces that would otherwise be occupied by the transformers. Another one of them is a mechanism to isolate the integrated transformers by depositing grounding stripes between every pair of inductors or grounding shields across layers so that undesirable cross-coupling can be removed or minimized.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A-FIG. 1D (Prior art) each show a type of winding configuration and represent a single transformer;

FIG. 2 shows an exemplary circuit that uses a first transformer M12 including two inductors L1 and L2 and a second transformer M34 including inductors L3 and L4;

FIG. 3A shows an exemplary winding configuration, referred to as single layer multi-interwound (SLMI);

FIG. 3B shows an equivalent schematic symbol or circuit of two transformers implemented in accordance with one embodiment of the present invention;

FIG. 3C shows two transforms integrated by winding stripes in parallel into a flat spiral within a predetermined silicon area;

FIG. 3D shows an improved design of the two transformers of FIG. 3C, in which a grounding is used to separate the two transformers so as to avoid cross-couplings between the transformers or among the inductors;

FIG. 3E shows a corresponding design of the winding configuration of FIG. 3A, in which a grounding is used to separate the two transformers so as to avoid cross-couplings between the transformers or among the inductors;

FIG. 3F.1 and FIG. 3F.2 each show a special winding configuration in which two transformers are integrated in a confined silicon space on a single layer with a grounding separator;

FIG. 3G shows a set of transformers integrated using single-layer multi-interwound configuration;

FIG. 4A shows an exemplary winding configuration, referred to as a multi-layer single-interwound (MLSI) type;

FIG. 4B shows an equivalent schematic symbol or circuit of one transformer implemented in accordance with one embodiment of the present invention (e.g., FIG. 4A);

FIG. 4C illustrates an exemplary transformer of the multi-layer multi-interwound type according to one embodiment of the present invention and uses grounding stripes to shield, prevent from or separate undesired couplings between inductors that are not supposed to be coupled;

FIG. 4D shows another integrated transformers formed by multi-layer multi-interwound;

FIG. 5A shows an exemplary winding configuration of single-overlay type using two layers of the same winding to form a transformer

FIG. 5B shows a transformer, called multi-layer single-overlay (MLSO), formed by two inductors, each is extended to a second layer, and can be extended to more layers in the similar fashion, if necessary;

FIG. 5C shows a winding configuration, referred to as a multi-overlay, which may also be viewed that the winding configuration is based on the features, benefits, and advantages of one or more of the above configurations;

FIG. 5D shows an equivalent schematic symbol or circuit of two transformers implemented in accordance with FIG. 5C;

FIG. 5E shows an improved design over FIG. 5C by deposing one or more groundings (e.g. stripes) to isolate one inductor from another;

FIG. 5F shows two transformers by multi-layer multi-overlay configuration;

FIG. 5G shows another two transformers by overlay configuration in which the stripes on the layers are interwound;

FIG. 6A shows an equivalent schematic symbol or circuit of an exemplary transformer with a single primary winding and several (two) secondary windings;

FIG. 6B shows a winding configuration of overlay-interwound with a center-tap transformer that corresponds to the transformer of FIG. 6A and includes two layers of stripe configurations;

FIG. 6C shows an equivalent schematic symbol or circuit in accordance with the secondary of the transformer in FIG. 6B;

FIG. 7A shows what is called tri-transformer including one primary winding with a center-tap and two separate overlaid secondary windings, each with a center-tap;

FIG. 7B shows the equivalent schematic symbol or circuit of the transformer of FIG. 7A; and

FIGS. 8A-8F shows, respectively, some possible configurations that may be derived from the present invention.

### DETAILED DESCRIPTION OF THE PREFERRED EMBODIMENT

The present invention pertains to integrating multiple transformers in silicon without occupying multiple individual silicon spaces that would otherwise be occupied by the multiple transformers. It is well understood that the multiple individual silicon spaces for the transformers can introduce undesirable parasitic effects (e.g. from extended connections around a circuit). The implementation of multiple transformers in a confined single silicon space will advantageously reduce the parasitic effects. As a result, an integrated circuit chip employing these transformers implemented in accordance with the present invention will be of small size and thus the cost of the integrated circuit chip can be substantially reduced. To remove or minimize undesired cross-couplings between inductors in a layer or inductors on layers that are not supposed to be coupled, a grounding stripe is formed, deposited, provided or deposited between the inductors or a grounding shield (wall) is provided across the layers. As a result the integrated transformers do not interfere with each other and perform as they were individually implemented.

The detailed description of the present invention is presented largely in terms of procedures, steps, logic blocks, processing, or other symbolic representations that directly or indirectly resemble the operations of electronic circuits or systems that process signals for desired outputs. These process descriptions and representations are typically used by those skilled in the art to most effectively convey the substance of their work to others skilled in the art. Reference herein to “one embodiment ” or “an embodiment ” means that a particular feature, structure, or characteristic described in connection with the embodiment can be included in at least one embodiment of the invention. The appearances of the phrase “in one embodiment ” in various places in the specification are not necessarily all referring to the same embodiment, nor are separate or alternative embodiments mutually exclusive of other embodiments.

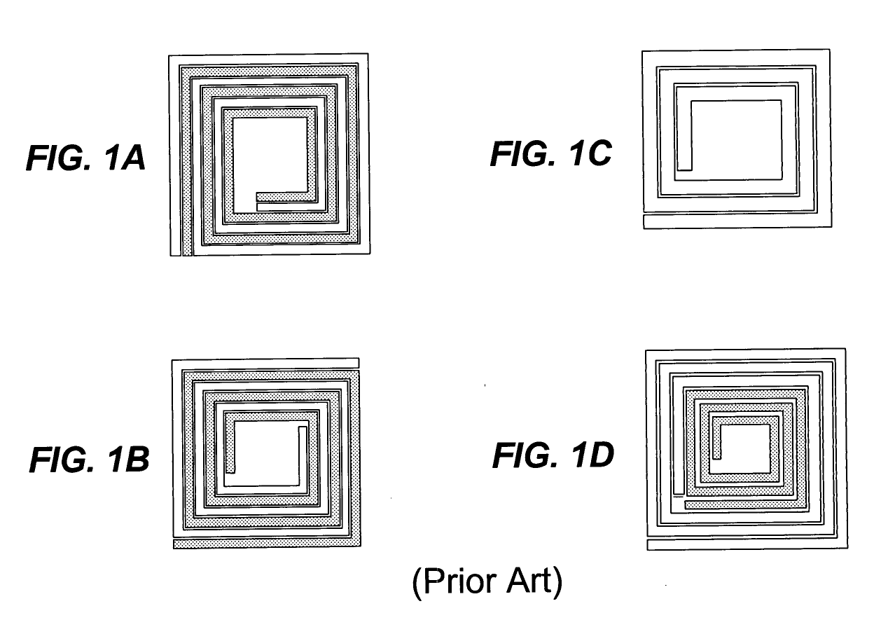

Embodiments of the invention are discussed herein with reference to FIGS. 1A-8F in which like numerals refer to like parts throughout the several views. However, those skilled in the art will readily appreciate that the detailed description given herein with respect to these figures is for explanatory purposes as the invention extends beyond these limited embodiments

Transformers can be found in many circuits. When integrated in silicon, transformers can provide useful performance characteristics, especially in processing high speed signals, thus one or more transformers will be used. FIG. 1A-FIG. 1D each show a type of winding configuration and represent a single transformer. When one of more such transformers are employed, each of the transformers will take an individual space on silicon. As the number of the transformers increases, the number of the individual space for the transformers is increased. Not only will the cost of a resulting integrated circuit be of considerably expensive, but also undesirable parasitic effects are introduced by connections to the transformers that are scattered around in a silicon layout, causing considerable instability of the circuit and significantly limiting the capability of processing signals at high frequency.

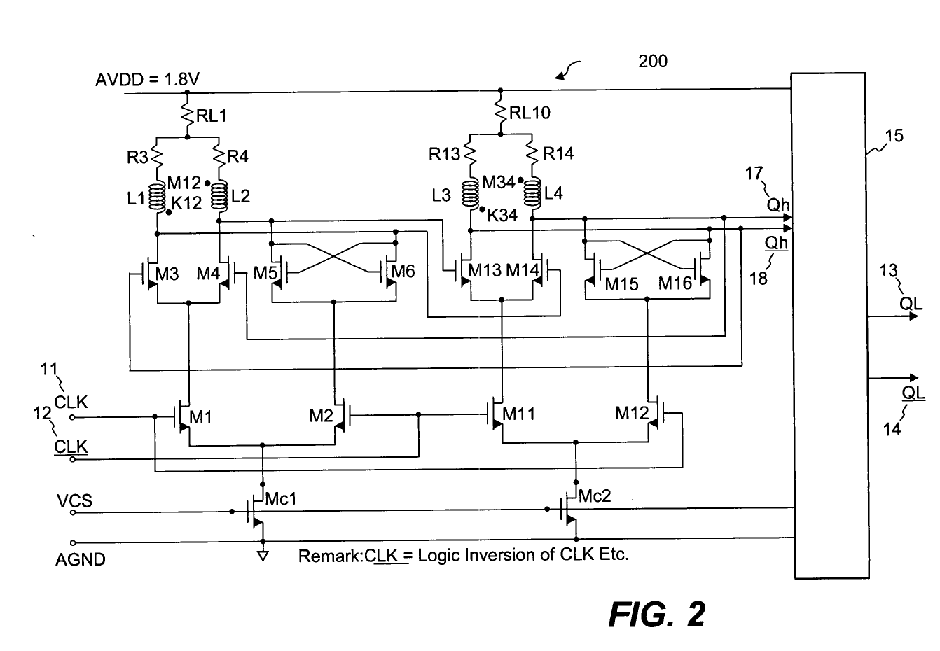

FIG. 2 shows an exemplary circuit 200 that uses a first transformer M12 including two inductors L1 and L2 and a second transformer M34 including inductors L3 and L4. In the prior art systems, the transformers are individually implemented, such as one of those in FIG. 1, resulting in an occupancy of multiple spaces of silicon area, each space for one transformer. It is well known in the art that the circuit itself (excluding the transformers) is of very small in size in a silicon layout. Accordingly, the transformers, being relatively big in size, are often placed outside of or surrounding the circuit, resulting in extended terminals of the transformers to the circuit and thus causing unnecessary parasitic effects that can significant impacts on the overall performance of the circuit. One of the key features in the present invention is to provide techniques to integrate two or more transformers in one silicon space without taking up multiple spaces. Thus not only is the overall silicon size for the circuit small, but the parasitic effects can be minimized.

In general, at silicon level, an inductor is created by a microstripe line and therefore sometimes referred to as monolithic implementation of a transmission line conductor. Given a predetermined area, a stripe is normally wound in a way to occupy a silicon area as small as possible. When two such inductors are arranged close enough to each other, as a result of magnetically coupling between the two inductors, a basic transformer (including a primary winding and a second winding) is created. Coupling is the extent to which the magnetic field of each coil overlaps the other coil. Coupling can range from 0% (no interaction at all) to 100% (full interaction). In essence, the physical characteristics of a basic transformer in silicon is controlled by at least these parameters: lengths and widths of the stripes, winding configuration of the two inductors (one as a primary and the other as a secondary), and spacing between the two inductors or possibly a type of material deposited between the two inductors. The corresponding electric physical characteristics of the transformer are thus a function of respective inductances of the inductors, and a coupling factor between the inductors.

Depending on the performance characteristics being sought from one or more transformers at silicon level, there can be a number of winding configurations. To facilitate the description of the present invention, it deems appropriate to describe respectively some of the key winding configurations. These winding configurations are related to each other and each is believed independently novel in the art.

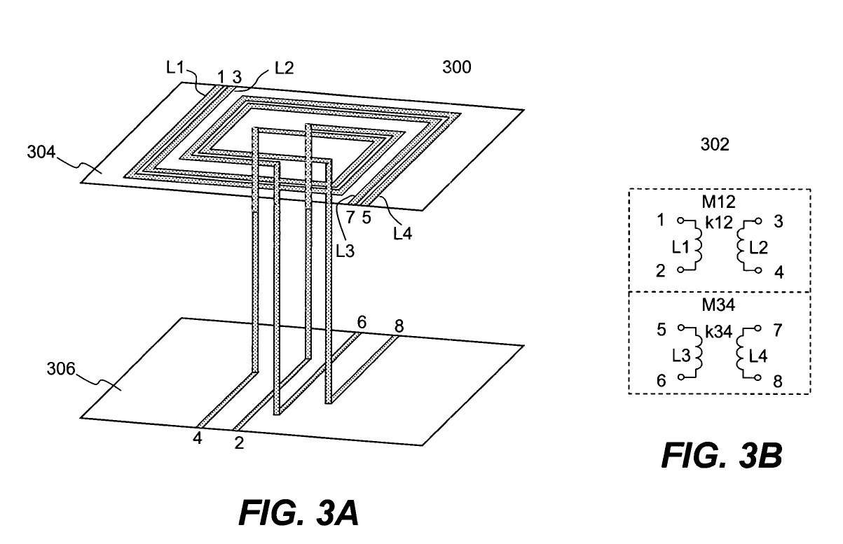

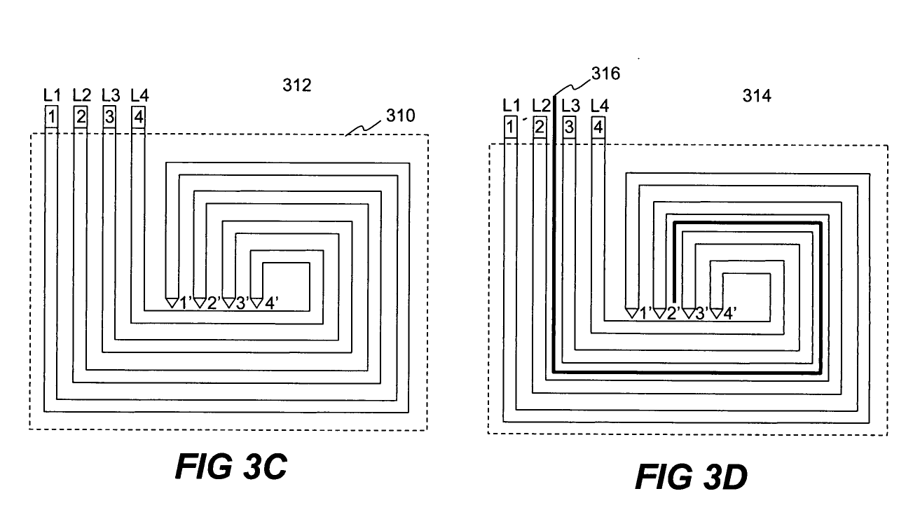

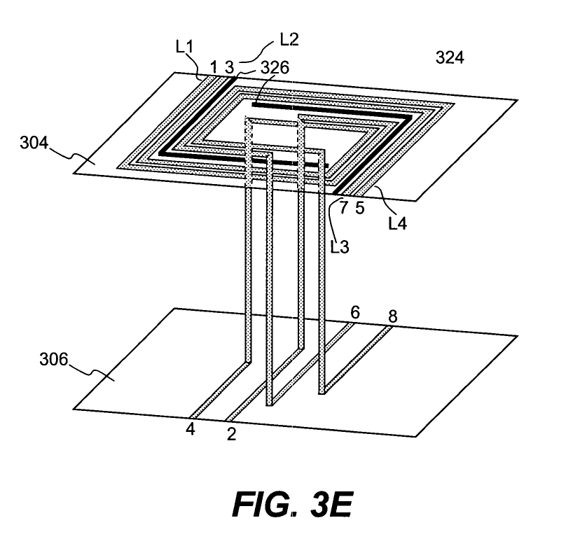

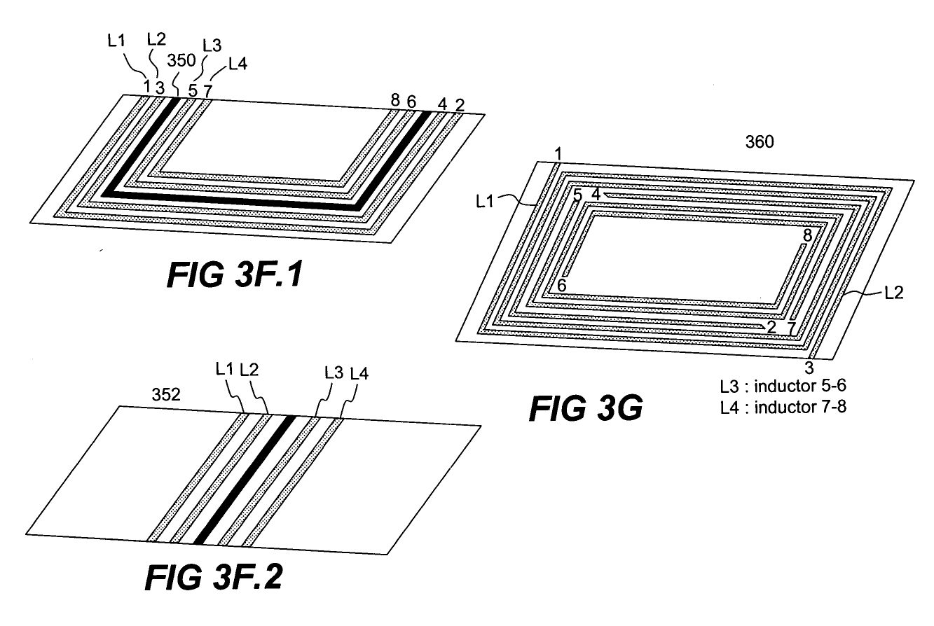

Referring now to FIG. 3A, there shows an exemplary winding configuration 300, referred to as a single-layer multi-interwound (SLMI) type. As the name suggests, transformers are formed by stripes interwound on a single layer. For simplicity, two transformers M12 and M34 are shown in FIG. 3A. The first transformer M12 is formed by two inductors L1 and L2 and the second transformer M34 is formed by two inductors L3 and L4. The equivalent schematic symbol or circuit of these two transformers is shown as a circuit 302 in FIG. 3B. As shown in FIG. 3A, both transformers M12 and M34 are formed on a single layer 304 (the layer 306 is for laying out the terminals). Each of the transformers M12 and M34 has a coupling factor K12 or K34, determined respectively, how the inductors L1 and L2 or L3 and L4 are coupled. As an example, the two transformers M12 and M34 can be used in FIG. 2.

According to one embodiment of the present invention, a number of conducting or semi-conducting stripes are wound in opposite into a flat spiral, namely circling around a central point in a flat curve or coiled on a substrate (e.g., CMOS). Depending on the design needs and available silicon space, the coiling shape may be of round or square on the substrate. FIG. 3A shows that a set of two stripes for inductors L1 and L2 are wound anti-clockwise into a flat spiral while a set of another two stripes for inductors L3 and L4 are wound clockwise and interlaced with that for inductors L1 and L2 into the flat spiral. In other words, the two sets of stripes are wound in opposite direction and between the spaces formed by the other set.

FIG. 3C shows a special case of the single-layer with multiple transformers in which stripes are wound in parallel into a flat spiral within a predetermined silicon area. As shown in FIG. 3C, four conducting stripes 312 are used to form two transformers M12 and M34. The equivalent schematic symbol or circuit of the two transformers M12 and M34 is similar to that shown in FIG. 3B. According to one embodiment of the present invention, a number of conducting or semi-conducting stripes are wound in parallel into a flat spiral, namely circling around a central point in a flat curve or coiled on a substrate (e.g., CMOS). The winding configuration as shown in FIG. 3C allows more transformers to be integrated in such fashion that the silicon space that would be otherwise occupied by individual transformers is substantially reduced.

However, it is noticed that as more transformers are integrated in accordance with FIGS. 3A or 3C, side facts, essentially unwanted transformers, are created among the inductors. The unwanted transformers could be formed by complicated couplings among the inductors L1, L2, L3 and L4. In a simplest term, each of the unwanted basic transformers is the result of the coupling between L1 and L3, L1 and L4, L2 and L3, or L2 and L4. More complicated transformers could be the result of cross-couplings among all the inductors. Unless characteristics from these couplings are intentionally used or well controlled, these unwanted transformers may potentially cause a circuit to malfunction or be unstable.

To overcome the side effects, FIG. 3D shows an improved design 314 over the design 312 of FIG. 3C according to one embodiment of the present invention. Essentially, a grounding stripe 316 is formed, placed or deposited between the inductors L2 and L3 such that the coupling between L1 and L3, L1 and L4, L2 and L3, or L2 and L4 are isolated, resulting in two independent transformers M12 and M34. Accordingly, the design 300 of FIG. 3A can be improved and the improved design 324 thereof according to one embodiment of the present invention is shown in FIG. 3E. A grounding stripe 326 is deposited between the conductors L2 and L4 or/and L1 and L3. By virtual of the present invention, a number of conducting or semi-conducting stripes are wound into a flat spiral on a type of substrate and one or more grounding stripe are respectively formed, placed or deposited between every set inductors (two or more) that form a transformer, creating a grounding shield between two transformers or among multiple transformers.

As the number of transformers integrated in accordance with FIG. 3A or FIG. 3C (or FIG. 3D or 3E) increases, the inductance of the individual inductors becomes limited. It can be appreciated from the configurations that the physical limitation of the spiral does not allow further winding with too many stripes in parallel. According to one embodiment, additional layers are employed. In other words, the individual stripes are extended to these additional layers so as to increase the inductance of each of the inductor and the coupling factor. The use of multiple layers for such purposes leads to another type of winding configuration referred to herein as multiple-layer interwound, the detail of which will be further provided below with other winding configurations.

FIGS. 3F.1 and 3F.2 show, respectively, that a special winding configuration 350 or 352 in which two transformers are integrated on a confined silicon space using simple transmission lines. The equivalent schematic symbol or circuit of these two transformers is similar to that shown as a circuit 302 in FIG. 3B. Similar to FIG. 3D, a ground stripe is placed between two inductors L2 and L3 such that no coupling can be occurred between L1 and L3, L1 and L4, L2 and L3 as well as L2 and L4. The winding configuration 350 or 352 can be useful when transformers with small inductance are needed (e.g., for circuitry operating in very high frequencies).

FIG. 3G shows a set of transformers 360 using single-layer multi-interwound configuration. As the names suggests, multiple transformers are integrated on a single layer and each of the transformers is formed by inductors whose stripes are interwound. As shown in FIG. 3G, a first transformer is formed by two inductors L1 and L2, the stripes thereof are interwound on the outskirt of a predetermined silicon area, a second transformer is formed by two inductors L3 and L4, the stripes thereof are interwound inside of the first transformer. If desired to isolate the two transformers, a grounding stripe may be placed between the two transformers. Namely the grounding stripe is placed to surround the second transformer such that no cross-coupling between the transformers or among the inductors.

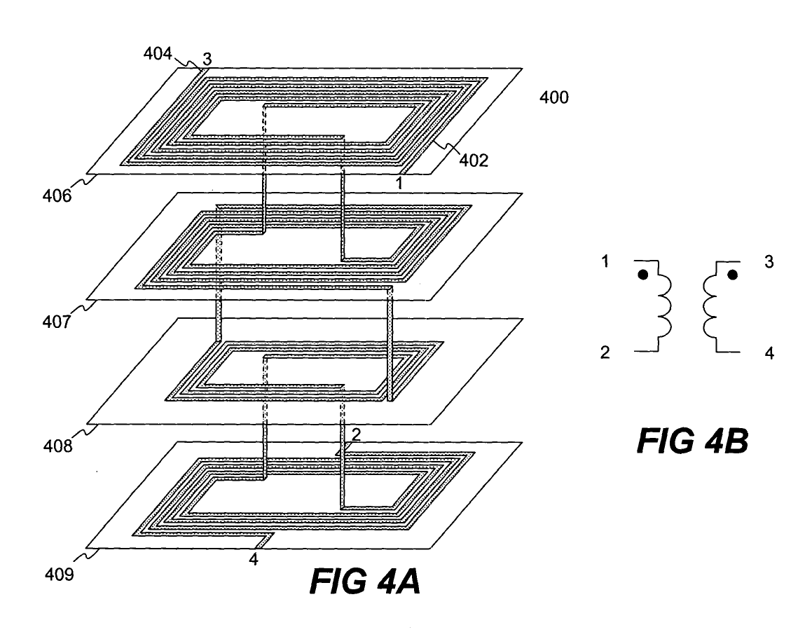

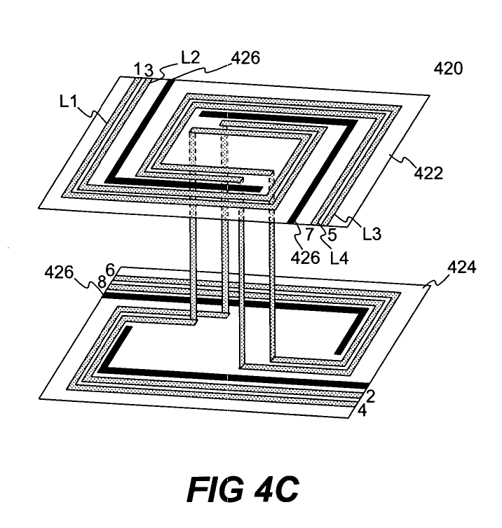

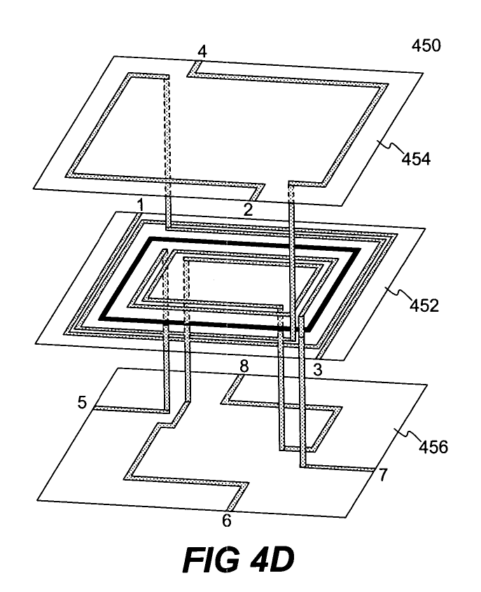

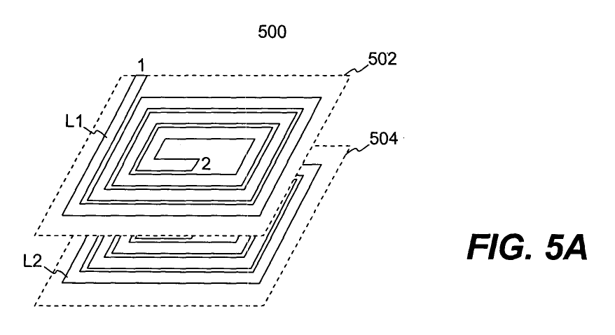

Referring now to FIG. 4A, there is an exemplary winding configuration 400, referred to as multi-layer interwound. As the name suggests, one or more layers are employed to extend the stripes of the individual inductors. FIG. 4A shows that a single transformer 400 is formed by two inductors 402 and 404. The two inductors 402 and 404 are formed by extending respective stripes continuously from a first layer 406 to a second layer 407, from the second layer 407 to a third layer 408, and from the third layer 408 to a fourth layer 409. As a result, the inductance of each of the two inductors 402 and 404 is significantly increased to meet a predetermined design requirement (e.g., L=100 nH). The equivalent schematic symbol or circuit of the transformer 400 is shown in FIG. 4B. Given the description herein, those skilled in the art can readily appreciate that the approach of using multiple layers may be extended to other winding configurations.

Each of the configurations FIG. 3A, FIG. 3C, FIG. 3D, FIG. 3E, FIG. 3F.1, FIG. 3F.2, FIG. 3G and FIG. 4A has its own unique features, benefits and advantages in creating integrated transformers in silicon. Given the description herein, a combination of some of the winding configurations can provide another winding configuration, referred to as a multi-layer multi-interwound type, which includes one or more layers. For example, multiple transformers are formed by interwinding the stripes that extend respectively to these one or more layers. FIG. 4C illustrates exemplary integrated transformers 420 of the multi-layer multi-interwound type. Two transformers 420 include two layers 422 and 424, each itself is a single-layer multi-interwound type. The inductors on each of the two layers 422 and 424 are connected to extend the inductance thereof. Thus, there are two transformers are formed, one with the inductors L1 and L2, the other with the inductors L3 and L4. The equivalent schematic symbol or circuit of the integrated transformers 420 is similar to that shown in FIG. 3B.

To avoid the unwanted couplings between the inductors L1 and L3, L1 and L4, L2 and L3, and L2 and L4 or cross-coupling among the inductors, one or more grounding stripes 426 can be placed, formed or deposited between two inductors that are not supposed to be coupled. In particular, when the inductors L1, L2, L3 and L4 are wound into a spiral on a layer (e.g., 422 or 420), a grounding stripe is always deposited between two inductors that are not supposed to be coupled. For example, a grounding metal stripe 426 is placed between two inductors L2 and L3 and also placed between the inductors L1 and L4, where the inductor L1 is wound next to the inductor L4.

According to one embodiment, respective grounding metal stripes on one layer are connected to grounding metal stripes on another layer to form essentially one or more grounding walls or shields to further reduce or shield possible cross-coupling between the layers. Such shields may be achieved with a through-wafer via technology process which sometimes is referred to as via etching.

FIG. 4D shows another integrated transformers 450 formed by multi-layer multi-interwound. The layer 452 is used to form two transformers by interwound configuration, two additional layers 454 and 456 are used not only to provide terminals of the inductors but also to wind the respective stripes in certain manner so as to extend the inductance thereof and facilitate to couple the transformers to other components in a circuit. In certain integrated circuits for high frequency applications, additional layers on which individual inductors are respectively extended may be used to satisfy what is referred to as Electrically Equivalent Geometry.

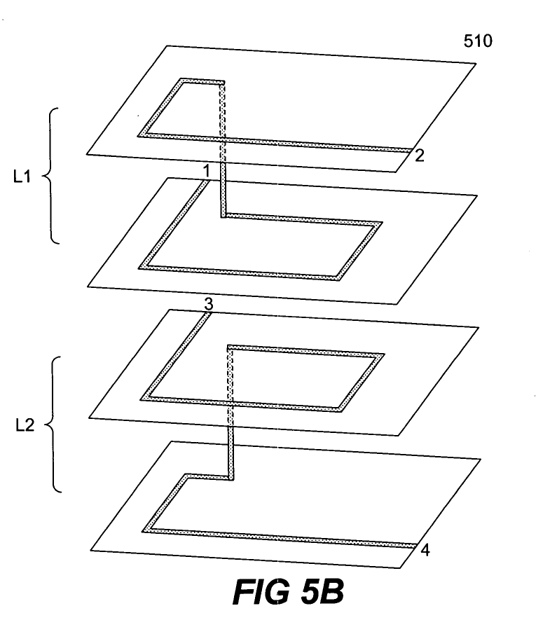

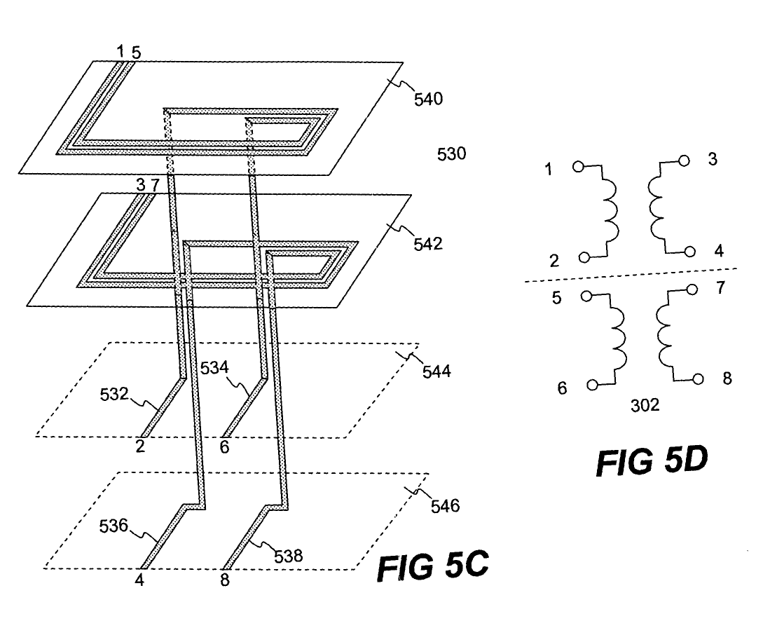

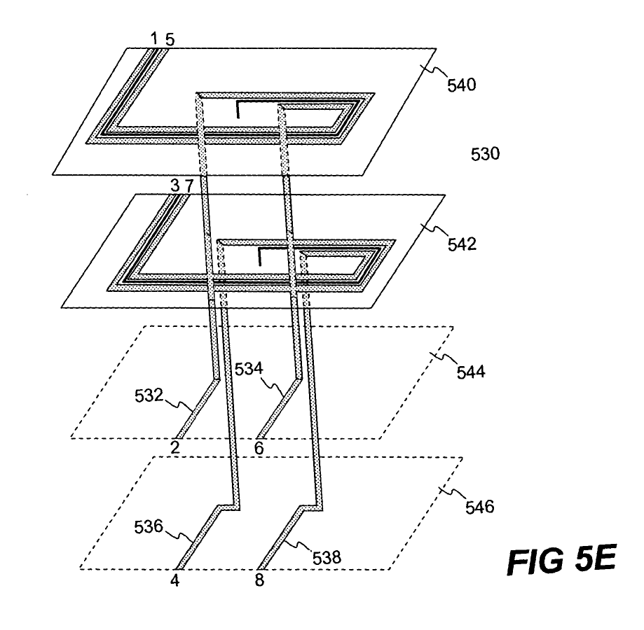

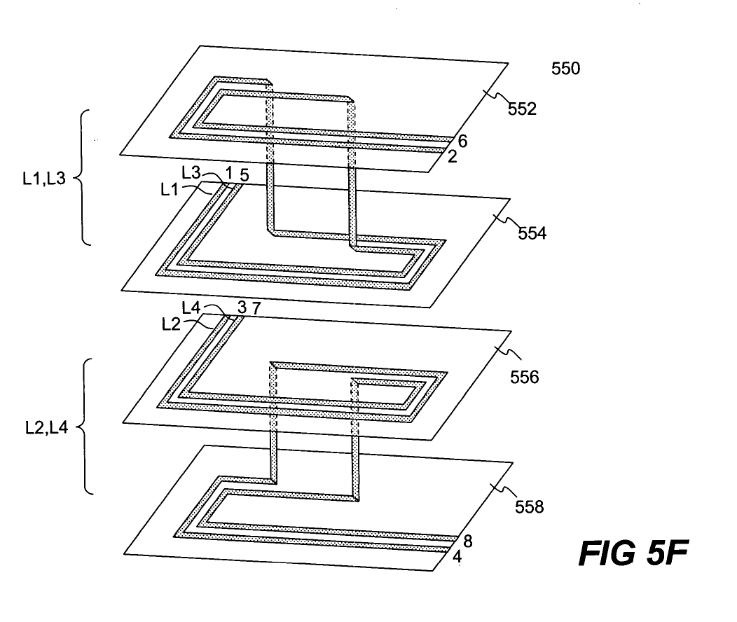

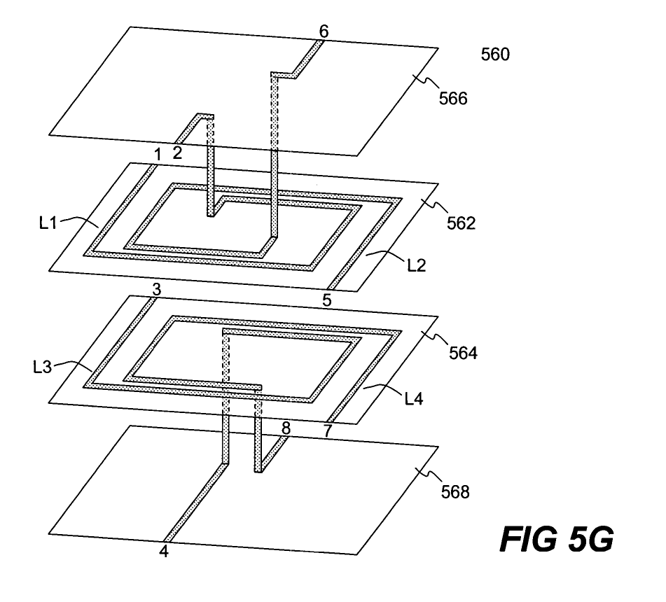

Referring now to FIG. 5A, there is an exemplary winding configuration 500, referred to as a single-overlay type. As the name suggests, two layers are employed to form a transformer instead of extending the stripes on the layers to increase the inductance. The winding configuration 500 includes two layers 502 and 504, each of the layers includes one individual inductor, the layer 502 has an inductor L1 and the layer 504 has an inductor L2. When the two layers 502 and 504 are arranged on top of each other, a transformer is created by coupling the inductors respectively on the layers 502 and 504. The equivalent schematic symbol or circuit of the transformer 500 is similar to that shown in FIG. 4B. When more inductance is sought, one or more layers can be added, in which case, these layers are for extending the stripes of each inductors and at the same time are arranged on top of each other to continue the coupling between the extended portions of the inductors. For example, a third layer having an inductor can be employed and electrically connected to the inductor on the layer 502 while a fourth layer having an inductor can be employed and connected to the inductor on the layer 504. When the third and fourth layers are, similar to the first and second layers 502 and 504, are arranged on top of each other, a transformer with increased inductances is thus formed. It can be appreciated that more layers may be employed accordingly to increase the inductance of either one or both of the inductors to meet a design requirement.

For simplicity, FIG. 5B shows a transformer 510 formed by two inductors L1 and L2, each is extended to a second layer, and can be extended to more layers in the similar fashion, if necessary. The transformer 510 is designed based on the winding configuration of the multi-layer single overlay type and is created by stacking or interlacing the layers.

To integrate two transformers together without increasing the occupying area, FIG. 5C shows a winding configuration 530, referred to as a multi-overlay, which may also be viewed that the winding configuration is based on the features, benefits, and advantages of one or more of FIG. 3A, FIG. 3C, FIG. 3D, FIG. 3E, FIG. 4A and FIG. 5A. The configuration 530 includes four individual inductors 532, 534, 536 and 538. In particular, a pair of inductors 532 and 534 is on a layer 540 and another pair of inductors 536 and 538 is on a layer 542. When these layers 540 and 542 are on top of each other, a first transformer including the inductors 532 and 536 and a second transformer including the inductors 534 and 538 are formed. The respective coupling factors are determined by the space, or a type of material if any, between the two layers 540 and 542. The layers 544 and 546 are provided to support the terminals of the inductors 532, 534, 536 and 538. The equivalent schematic symbol or circuit of the transformers of FIG. 5C is shown in FIG. 5D.

It is assumed that the inductors 532, 534, 536 and 538 are labeled as L1, L2, L3 and L4. Thus the first transformer MI is formed by L1 and L3 and the second transformer M2 is formed by L2 and L4. However, unwanted transformers including those formed by L1 and L2, L3 and L4, L1 and L4, and L2 and L3 due to the coupling effects between these inductors can be created when the layers 540 and 542 are arranged on top of each other to form the transformers Ml and M2. In fact, it can be appreciated that the practical results involving cross-couplings can be more complicated than that just described when the layers 540 and 542 are so arranged.

According to one embodiment of the present invention, FIG. 5E shows an improved design 530 over FIG. 5C by deposing one or more groundings (e.g. stripes or walls) to isolate one inductor from another. In particular, a grounding stripe is placed between the two inductors on the layers 540 and 542. Not shown in the figure, a ground wall can be formed by a vertical conducting curtain between the two stripes on the layers 540 and 542. Experiments have indicated that those unwanted transformers are thus eliminated or significantly reduced, making it now possible to integrate more transformers in a relatively small silicon space.

FIG. 5F shows two transformers 550 by multi-layer multi-overlay configuration. The equivalent schematic symbol or circuit of the transformers 550 is similar to that shown in FIG. 3B. Two inductors L1 and L3 are formed on layers 552 and 554, another two inductors L2 and L4 are formed on layers 556 and 558. When the four layers are stacked or interlaced on top of each other, a first transformer is formed by the inductors L1 and L2, and a second transformer is formed by the inductors L3 and L4. If necessary, a ground strip may be placed between the two inductors L1 and L3 on layers 552 and 554, as well as between the two inductors L2 and L4 on layers 556 and 558. For even better isolation, one or more grounding walls may be formed or placed across the layers.

FIG. 5G shows another two transformers 560 by interwound-overlay configuration in which the stripes on the layers are interwound. As shown in FIG. 5G, a first transformer by two inductors L1 and L3 is formed by interwinding the respective stripes on layer 562 and a second transformer by two inductors L2 and L4 is formed by interwinding the respective stripes on layer 564. It is also possible to form two transformers by the conductors L1 and L2 as well as L3 and L4. The two layers 566 and 568 are provided for the terminals of these inductors and may also increase the inductance of the inductors. To facilitate the description of the winding configuration, the first set of the transformers is discussed herein. When the four layers are overlaid (e.g. stacked or interlaced) on top of each other, the first transformer is thus formed by the inductors L1 and L3, and the second transformer is formed by the inductors L2 and L4. The equivalent schematic symbol or circuit of the transformers 560 is similar to that shown in FIG. 3B. Preferably, a ground strip is placed between the two inductors respectively on layers 562 and 564 or a grounding wall between the layers 562 and 564. In addition, the conducting stripes for the conductors L1, L2, L3 or L4 can be extended to one or more other layers to increase inductance thereof.

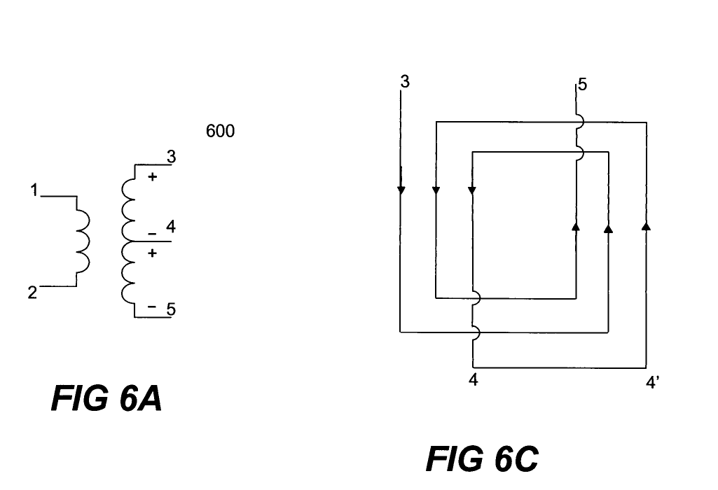

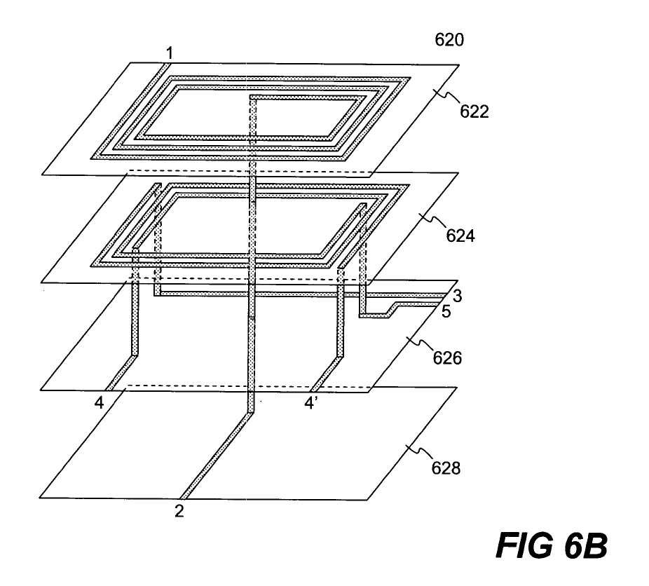

In some applications or designs, a transformer may be configured to have several secondary windings, each resulting in a different output (e.g., voltage). An equivalent schematic symbol or circuit of an exemplary transformer 600 is shown in FIG. 6A in which a primary winding (i.e., an inductor L12) is coupled with two secondary windings (i.e., inductors L34 and L45). For any given voltage across the primary, the voltage across each of the secondary windings is essentially determined by the number of turns in each secondary. A winding may be center-tapped as shown in the figure. To center tap a winding means to connect a wire to the center of the coil, so that between this center tap and either terminal of the winding there appears one-half of the voltage developed across the entire winding.

FIG. 6B shows a winding configuration 620 of a center-tap transformer that corresponds to the transformer 600 of FIG. 6A and includes two layers 622 and 624 (the layers 626 and 628 are for the terminals of the transformer). The winding configuration 620 is a type of overlay and forms the transformer 600 when the two layers 622 and 624 are arranged on top of each other. In particular, there is one inductor L12 as the primary on the layer 622 and there are two inductors L34 and L4′5 as the secondary on the layer 626. To function the transform as shown in FIG. 6A, the terminals 4 and 4′ are connected together to a component (e.g., a transistor, a resistor, GND or VDD). A corresponding current flow illustration of the secondary winding is shown in FIG. 6C which also demonstrates the current symmetry in the transformer 600.

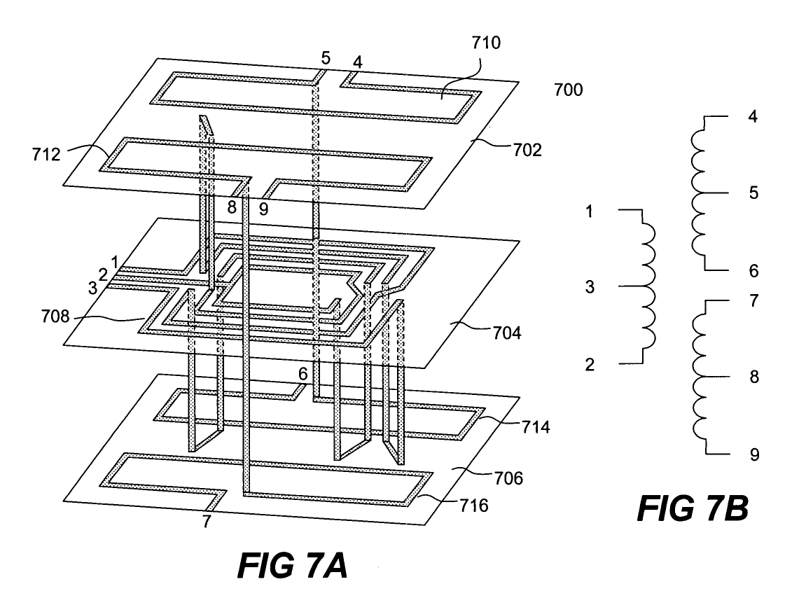

FIG. 7A shows what is called tri-transformer 700 including one primary winding with a center-tap and two separate secondary windings that overlay the primary winding, each of the secondary windings includes a center-tap. The equivalent schematic symbol or circuit of the transformers 700 is shown in FIG. 7B. In other words, both of the secondary windings are coupled with the primary winding. According to one embodiment, the tri-transformer 700 is created using three layers 702, 704 and 706. The primary winding is essentially formed on the center layer 704. The stripe 708 for the primary winding is wound around a flat spiral that has a shape in accordance with a predefined area in silicon for the transformer 700. To avoid electrical connect to the center tap, the stripe 708 extends to the layers 702 and 706 to skip over those portions that have been wound on the layer 704. The two secondary windings are formed jointly on the layer 702 and 706. In other words, to have a strong coupling with the primary winding, a first part of both secondary windings are formed on the layer 702 with minimized coupling between the first part 710 of the first secondary winding and the first part 712 of the second secondary winding. As shown in FIG. 7A, the first parts 710 and 712 of the first and second secondary windings are individually wound on the layer 702. If necessary, a grounding stripe may be placed between these two first parts 710 and 712.

Similarly, the second parts 714 and 716 of the first and second secondary windings are similarly formed on the layer 706 with minimum coupling therebetween. Again, If necessary, a grounding stripe may be placed between these two second parts 714 and 716. When these three layers 702, 704 and 706 are on top of each other, the tri-transformer 700 is created by the coupling between the primary and the first secondary as well as the second secondary.

According to one embodiment of the present inventions, one of the applications of the transformers used in integrated circuits is to adjust parasitic effects in favor to the performance of the integrated circuits when the signal frequency goes beyond certain ranges. It is well known in the art that the parasitic effects (e.g., parasitic capacitance) in components such as transistors can cause artifacts to output signals of a circuit or destabilize the circuit, thus limiting the frequency of the signal applied to the circuit. As shown FIG. 2, when a transformer is employed in a difference circuit, together with special designs of the transistors or resistors, resonant filtering can be inherently provided to minimize harmonic components in output signals from the circuit. As a result, the circuit is capable of processing signals of higher frequencies.

It has been known that the transformers can be used in many circuits. Efforts have been in the past to incorporate the transformers in integrated circuits, but resulting in expensive chips. With the present invention, it is now possible to employ transformers in many integrated circuits to improve their abilities to handle high-speed signals, such as transceivers, optical communication circuits and voltage control oscillators (VOC).

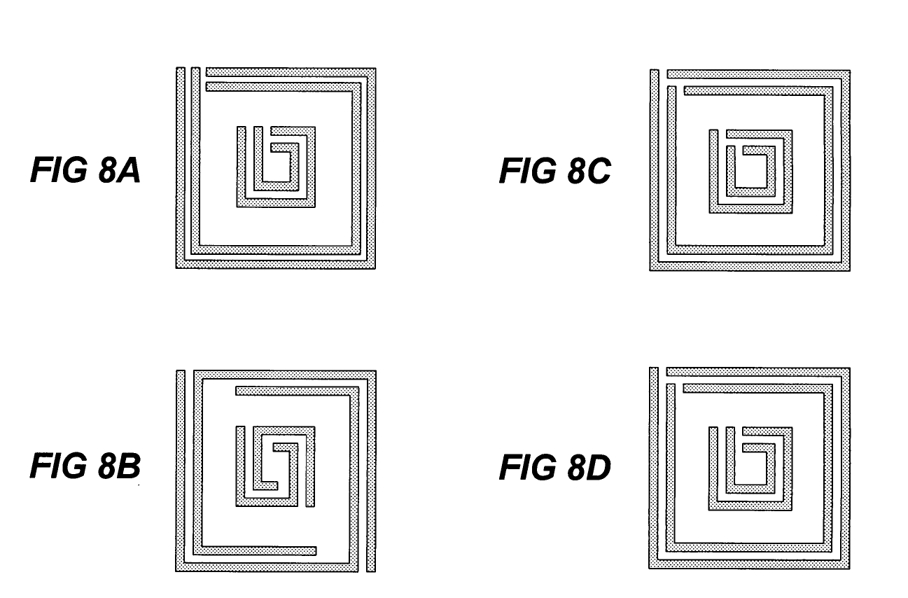

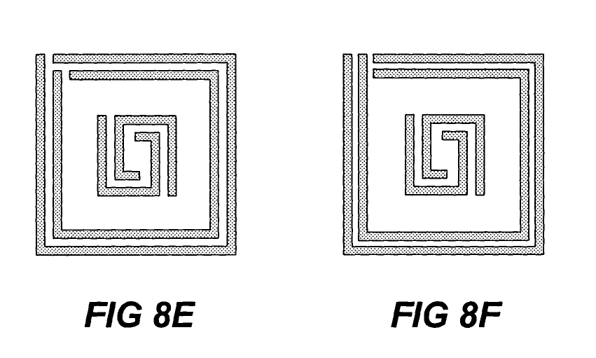

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, there are other possible configurations as shown in FIGS. 8A-8F, one or more grounding stripes may be used to isolate one transformer from another. When multiple layers are stacked on top of each other (e.g. more inductance), grounding walls may be used across the layers to minimize cross coupling between the layers. Accordingly, the scope of the present invention is defined by the appended claims rather than the foregoing description of embodiment.

We claim:

1. N integrated transformers comprising:
a plurality of conducting stripes formed closely to each other in silicon, each two adjacent stripes of the conducting stripes forming one of the N transformers; and
wherein none of the conducting stripes are electrically connected and N is a finite integer greater than or equal to 2.

2. The transformers as recited in claim 1 further comprising:
a grounding stripe deposited between two adjacent transforms of the N transformers to shield cross-coupling between the two adjacent transforms.

3. The transformers as recited in claim 1, wherein the conducting stripes are on a layer and wound in parallel into a flat spiral that has a shape in accordance with a predefined area in silicon for the transformers.

4. The transformers as recited in claim 1, wherein the conducting stripes are transmission lines on a layer and wound in parallel in an available area.

5. The transformers as recited in claim 1, wherein a first set of the conducting stripes are on a layer and wound in parallel into a flat spiral that has a shape in accordance with a predefined area in silicon for the transformers, and a second set of the conducting stripes are on the same layer and wound in parallel into the same flat spiral but in opposite direction to the first set.

6. The transformers as recited in claim 5, wherein the first set and the second set of the conducting stripes are interlaced with each other.

7. The transformers as recited in claim 5, wherein the conducting stripes are respectively extended to one or more layers to increase conductance of each of the conducting stripes, the one or more layers are within a silicon space.

8. The transformers as recited in claim 1, wherein the conducting stripes are extended to one or more layers for increased inductance in each of the conducting stripes.

9. The transformers as recited in claim 8, wherein the extended portions of the conducting stripes on the one or more layers being arranged in a similar fashion as those of the conducting stripes on a first layer.

10. The transformers as recited in claim 9, wherein the one or more layers are stacked on top of each other, one or more grounding walls are formed across the layers to minimize cross-coupling between or among the layers.

11. The transformers as recited in claim 1, wherein a first half of the conducting stripes are in a first layer and a second half of the conducting stripes are in a second layer, and wherein the first layer and the second layer are arranged on top of each other such that the first half of the conducting stripes correspond to the second half of the conducting stripes to form the N integrated transformers.

12. The transformers as recited in claim 11, wherein there is a grounding stripe to separate one conducting stripe from another in the first layer and the second layer to shield any possible cross-coupling among the N integrated transformers.

13. The transformers as recited in claim 11, wherein the first half of the conducting stripes are extended to a first set of one or more layers for increased inductance in each of first half of the conducting stripes, the second half of the conducting stripes are extended to a second set of one or more layers for increased inductance in each of second half of the conducting stripes, and wherein the first and second set of one or more layers are stacked or interlaced on top on each other to form a pair of two layers to extend the transformers formed on the first two layers.

14. The transformers as recited in claim 13, wherein a grounding stripe is formed between every two of the conducting stripes to minimize cross-coupling among the transformers.

15. The transformers as recited in claim 13, wherein a grounding wall is formed across the layers to minimize cross-coupling among the layers.

16. The transformers as recited in claim 1, wherein the conducting stripes are communication lines extended to a plurality of several layers that are stacked on top of each other.

17. The transformers as recited in claim 1, wherein at least one of the N transformers are surrounded by many others of the N transformers on a layer.

18. The transformers as recited in claim 1, wherein the N integrated transformers are employed in an allocated silicon space for an integrated circuit.

19. The transformers as recited in claim 18, wherein the N integrated transformers are used to replace N similar transformers that would otherwise occupy multiple silicon spaces for the N similar transformers.

20. The transformers as recited in claim 18, wherein each of the N integrated transformers is employed in a differential circuit in the integrated circuit, together with parasitic effects of transistors in the differential circuit, to provide resonant filtering to minimize artifacts or distortions in signals processed in the differential circuit.

21. N integrated transformers comprising:
a first group of N conducting stripes formed in a first layer, the first group of the N conducting stripes wound into a first flat spiral on the first layer;
a second group of N conducting stripes formed in a second layer, the second group of the N conducting stripes wound into a second flat spiral on the second layer,
wherein the first flat spiral and the second flat spiral are substantially identical so that the first group of the N conducting stripes correspond to the second group of the N conducting stripes when the first layer and the second layer are on top of each other, and
wherein none of the conducting stripes are electrically connected and N is a finite integer greater than or equal to 2.

22. The transformers as recited in claim 21, wherein a grounding stripe is deposited between every two of the N conducting stripes on the first layer and the second layer such that undesired cross-couplings between or among some of the N conducting stripes on the first layer and the second layer are minimized.

23. The transformers as recited in claim 22, wherein the first group and the second group of the N conducting stripes are continuously extended to one or more layers to increase inductance of each of the N conducting stripes.

24. The transformers as recited in claim 23, wherein the extended portions of the N conducting stripes are also wound in similar fashion to that in the first and/or second layer.

25. The transformers as recited in claim 24, wherein, when the first, the second and the one or more layers are stacked, each of the transformers has increased inductance and coupling factor.

26. The transformers as recited in claim 25, wherein a grounding wall is formed across the layers to minimize undesirable cross-coupling between or among the layers.

27. The transformers as recited in claim 26, wherein the grounding wall is formed by a through-wafer via technology process.

28. The transformers as recited in claim 21, wherein a grounding stripe is formed between each two of the N conducting stripes are transmission lines on a layer and wound in parallel in an available area around a circuit.

29. A method for forming N integrated transformers, the method comprising:
forming a plurality of conducting stripes closely to each other in silicon, each two adjacent stripes of the conducting stripes forming one of the N transformers when signals with frequencies pass through the N transformers; and
wherein none of the conducting stripes are electrically connected and N is a finite integer greater than or equal to 2.

30. The method as recited in claim 29 further comprising:
forming, placing or depositing a grounding stripe between two adjacent transforms of the N transformers to shield cross-coupling between the two adjacent transforms.

31. The method as recited in claim 29, wherein the conducting stripes are on a layer and wound in parallel into a flat spiral that has a shape in accordance with a predefined area in silicon for the transformers.

32. The method as recited in claim 29, wherein the conducting stripes are respectively extended to one or more layers to increase conductance of each of the conducting stripes, the one or more layers are within a silicon space.

33. The method as recited in claim 32, further comprising forming a grounding wall across the layers to shield cross-coupling between and among the layers.

34. The method as recited in claim 29, wherein a first set of the conducting stripes are on a layer and wound in parallel into a flat spiral that has a shape in accordance with a predefined area in silicon for the transformers, and a second set of the conducting stripes are on the same layer and wound in parallel into the same flat spiral but in opposite direction to the first set.

35. The method as recited in claim 34, wherein the first set and the second set of the conducting stripes are interlaced with each other.

36. The method as recited in claim 29, further comprising extending the conducting stripes to one or more layers for increased inductance in each of the conducting stripes.

37. The method as recited in claim 36, wherein the extended portions of the conducting stripes on the one or more layers being arranged in a similar fashion as those of the conducting stripes on a first layer.

38. The method as recited in claim 37, further comprising stacking the one or more layers in a silicon area.

39. The method as recited in claim 29, wherein a first half of the conducting stripes are in a first layer and a second half of the conducting stripes are in a second layer, and wherein the first layer and the second layer are arranged on top of each other such that the first half of the conducting stripes correspond to the second half of the conducting stripes to form the N integrated transformers.

40. The method as recited in claim 39, further comprising forming, placing or depositing a grounding stripe to separate one conducting stripe from another in the first layer and the second layer to shield any possible cross-coupling among the N integrated transformers.

41. The method as recited in claim 40, wherein the first half of the conducting stripes are extended to a first set of one or more layers for increased inductance in each of first half of the conducting stripes, the second half of the conducting stripes are extended to a second set of one or more layers for increased inductance in each of second half of the conducting stripes, and the method further comprising causing the first and second set of one or more layers to be stacked or interlaced on top of each other to form a pair of two layers to extend the transformers formed on the first two layers.

42. The method as recited in claim 41, the method further comprising forming, placing or depositing a grounding stripe between every two of the conducting stripes to minimize cross-coupling among the layers.

43. The method as recited in claim 39, further comprising forming a grounding wall across the layers to shield cross-coupling between or among the layers.

44. The method as recited in claim 29, wherein the conducting stripes are communication lines extended to a plurality of several layers that are stacked on top of each other.

45. The method as recited in claim 29, wherein the N integrated transformers are formed in an allocated silicon space for an integrated circuit including transistors and resistors.

46. The method as recited in claim 29, wherein each of the N integrated transformers is employed in a differential circuit in the integrated circuit, together with parasitic effects of transistors in the differential circuit, to provide resonant filtering to minimize artifacts or distortions in signals processed in the differential circuit.

47. The method as recited in claim 29, wherein at least one of the N transformers are surrounded by many others of the N transformers on a layer.
